(19) United States
(12) Patent Application Publication
(10) Pub. No.: US 2007/0175829 A1
(43) Pub. Date: Aug. 2, 2007

(54) Pressure driven separation of liquid feeds

(75) Inventors: Ivo Vankelecom, Ternat (BE); Lieven Gevers, Mchelen (BE); Pierre Jacobs, Gooik (BE)

Correspondence Address: CLARK & ELBING LLP, 101 FEDERAL STREET, BOSTON, MA, 02110, US

(73) Assignee: K.U.LEUVEN RESEARCH AND DEVELOPMENT, Leuven (BE)

(21) Appl. No.: 10/596,577

(22) PCT Filed: Dec. 16, 2004
(86) PCT No.: PCT/BE04/00177

§ 371 Date: Jun. 16, 2006

(30) Foreign Application Priority Data
Dec. 16, 2003 (GB) 0329106.9

(51) Int. Cl. B01D 61/00

(52) U.S. Cl. 210/650; 210/500.1; 210/506

(57) ABSTRACT

Membranes consisting of an elastomeric matrix with dispersed fillers are used in the pressure driven separation of liquid feeds. The fillers are selected in such a way that the interactions between the filler and the elastomer keep the membrane swelling limited, resulting in higher rejections.

### BACKGROUND OF THE INVFNTION

The present invention relates to the use of membranes prepared from filled elastomers for the separation of liquids in a pressure driven membrane separation process.

In a pressure driven membrane process, two or more components are separated over a membrane by means of a pressure gradient, generated by a gas pressure or a mechanical pressure. The pressure driven membrane processes on liquid feeds can be divided in 4 groups, depending on the applied pressure, for which typical values are given in table 1 (Mulder, 1996).

TABLE 1
Pressure driven membrane processes.

| | Typical | Typical | Morphology of |
|---|---|---|---|
| Membrane | pressure | flux | the selective |
| process | (bar) | (1/(m² · h · bar)) | layer |
| Microfiltration | 0.1-2 | >50 | Porous |
| Ultrafiltration | 1-5 | 10-50 | Porous |
| Nanofiltration | 5-20 | 1.4-12 | Porous/Dense |
| (Hyperfiltration) | | | |
| Reverse Osmosis | 10/100 | 0.05-1.4 | Dense |

Several membrane separation processes of the prior art use pervaporation for separation or purification of various liquid mixtures by partial vaporization through a membrane. A partial pressure gradient is the driving force. Pervaporation is uniquely characterised by the involvement of an evaporation step of the transported compounds at the permeate side. The driving force over the membrane is maintained via the continuous removal of the evaporated compounds by means of a vacuum pump or a sweep gas to keep the separation running.

Pervaporation is in particular a process in which a liquid stream containing two or more components is placed in contact with one side of a non-porous membrane preferably polymeric while a vacuum or gas purge is applied to the other side. The components in the liquid stream sorb into the membrane, permeate through the membrane, and evaporate into the vapor phase (hence the word pervaporate). The vapor, referred to as “the permeate”, is then condensed. Due to different species in the feed mixture having different affinities for the membrane and different diffusion rates through the membrane, a component at low concentration in the feed can be highly enriched in the permeate.

The membrane separation process of present invention is a “pressure driven membrane process” which is clearly different from pervaporation. A pressure driven membrane process is in the meaning that it involves a process of separating two or more components over a membrane by means of a pressure gradient, generated by a means that generates pressure at the feeding site for instance by a means to generate a gas pressure or by a means to generate a mechanical pressure.

In a pressure driven membrane process, the volume flux depends on the hydraulic resistance of the membrane used and the pressure drop over the membrane. In general, the inverse of the resistance is used and defined as the hydraulic permeability and this permeability depends on the pore size and structure, the porosity and the thickness of the membrane. The rejection of solutes by the membrane is determined by different mechanisms, such as the distribution of components between liquid phase and membrane phase, the interaction of solutes with the pore wall or polymer chains, and the interaction of solutes with other components in the solution. Unwanted swelling of the separation membrane will disturb the separation by the pressure driven membrane process for instance by decreasing the selectivity of the separation process.

In the past, the pressure driven processes have mainly been used in the treatment of water. Recently, a growing interest exists to use these processes in the treatment of non-aqueous streams. Examples of applications are: separation of dyes, surfactants, enzymes or proteins out of solvents, fractionation of polymers, separation of dissolved catalysts from products and solvents, separation of pharmaceutical intermediates and products from solvents, separation of triglycerides and phospholipids from oil miscella, oil deacidification, recovery of extraction solvents, separation of hydrocarbons and lube oils from solvents, solvent exchange, . . .

For pressure driven processes are porous membranes commonly used. The present invention, however, relates to the use of dense membranes in pressure driven separation processes of liquid feeds, more in particularly to membranes with a selective layer prepared from a filled elastomeric polymer. Typical but not exclusive examples of such elastomeric polymers are polydimethylsiloxane (silicone rubber), polyisobutene (butyl rubber), polybutadiene, polychloroprene, polyisoprene, styrene-butadiene rubber, acrylonitrile-butadiene rubber (NBR), ethene-propene-diene-rubber (EPDM) and acrylonitrile-butadiene-styrene ABS) (Mulder, 1991).

has been found that elastomers have a high permeability rendering them suitable for the manufacture of membranes for use in pressure driven separation processes of liquid feeds, however excessive swelling in certain solvents and higher temperatures can lead to unacceptably low membrane selectivity.

Most elastomers have limited chemical resistance and tend to swell or even dissolve in most of the solvents. When preparing membranes from these materials, this characteristic mostly results in a high permeability, but in a rather poor selectivity and stability. When coated on a support layer, the swollen elastomer can crack or delaminate from the substrate, because of increased interfacial tensions. This decreased selectivity and stability gets even more problematic at high temperatures.

In pressure driven membrane processes, the use of additional cross-linking (e.g. WO 96/27430) and the selection of more stable rubbers, like fluorosilicones (e.g. U.S. Pat. No. 4,748,288), have been suggested as solutions for this kind of problem.

A solution to this swelling problem could eventually be the use of top layers based on filled elastomers. Membranes with top layers based on silicone rubber are currently used in pressure driven membrane separations of non-aqueous solutions. U.S. Pat. Nos. 5,265,734 and 5,205,934 describe the preparation of silicone-derived solvent stable membranes. These membranes are used to separate catalysts from solvents and products (U.S. Pat. No. 5,681,473), for solvent recovery and partial deacidification of vegetable oils (aman et al.(1996)), . . . Bitter (U.S. Pat. No. 4,748, 288) used a silicone based membrane to separate hydrocarbon oils from solvents, while Banushali et al. (2001) used a similar membrane from Osmonics to investigate transport mechanisms. None of these membranes contained fillers.

Present invention, proposes a solution to the swelling problem by use of filled or hybrid elastomeric membranes for the separation of liquid feeds via pressure driven process. The selective top-layer of these membranes consists of an elastomer in which an organic or inorganic filler is dispersed.

One type of preferred fillers are molecular sieves or porous materials with nanometer dimension (0.3-10 nm) windows, channels and cavity architectures such as zeolites and mesoporous materials. Apart from zeolites and mesoporous materials, other fillers like silica, alumina, titania and carbon molecular sieves can be used or any particle from an inorganic or organic nature, which are in a solid state and interact chemically and/or physically with the elastomer to cause an additional cross-linking sufficient to reduce the swelling of the elastomer mebranes in high-swelling solvents and/or at high temperatures.

### SUMMARY OF THE INVENTION

This invention includes the use of filled elastomers in the separation of liquid feeds via pressure driven membrane processes. Elastomers are interesting materials, because of their high permeability. However, excessive swelling in certain solvents and at higher temperatures can lead to unacceptably low membrane selectivities. In this invention, strongly interacting fillers are added to the elastomers resulting in maintained high membrane selectivity in pressure driven membrane separation of liquid feeds, even in high-swelling solvents and at higher temperatures.

One embodiment of present invention is pressure-driven separation of liquid feeds using a membrane, consisting of an elastomer in which a filler is dispersed in such a way that strong (filler/matrix) interactions limit the swelling of the membrane. These membranes can be elastomeric comprising a filler that results in a swelling reduction of the elastomeric membrane of at least 3%. In a preferred embodiment the swelling reduction results in an increase of the rejection of the elastomeric membrane for solutes of at least 3%. Preferably the filler is a zeolite and most preferably the zeolite has a ZSM-5 structure or a USY structure. In one embodiment the elastomer is a polysiloxane and preferably the polysiloxane is a polydimethylsiloxane or the elastomer can be EPDM.

### DETAILED DESCRIPTION OF TEE INVENTION

As stated, this invention relates to membranes of which the selective layer consists of a filled elastomer. Following the ASTM (American Society for Testing and Materials) standards, ‘elastomers’ are defined as “macromolecular materials that return to approximately the initial dimensions and shape after substantial deformation by a weak stress and release of the stress”. Elastomers are sometimes also referred to as ‘rubbery materials’. A ‘rubber’ is defined as “a material that is capable of recovering from large deformations quickly and forcibly, and can be, or already is, modified to a state in which it is essentially insoluble (but can swell) in boiling solvent, such as benzene, toluene, methyl ethyl ketone, and ethanol/toluene azeotrope”.

The most important elastomers are polyisoprene (natural or synthetic rubber (IR)), polychloroprene (chloroprene rubber (CR)), butyl rubber (BR), styrene-butadiene rubber (SBR), acrylonitrile-butadiene rubber (NBR), ethene-propene-diene-rubber (EPDM), acrylonitrile-butadiene-styrene (ABS), chlorosulfonated polyethylene (CSM), polyacrylate (polyacrylic rubber), polyurethane elastomers, polydimethylsiloxane (PDMS, sometimes more generally referred to as silicone rubber), fluorosilicones and polysulfides.

In this invention, the most important characteristic of elastomers is the chemical resistance. Most elastomers experience changes upon contact with organic solvents, in the following manner:
1. Swelling
2. Dissolution
3. Breaking of chemical bonds by
   A. Hydrolysis/solvolysis
   B. Oxidation
4. Combination of 1,2 and 3

In table 2, indications of the chemical resistance of different elastomers are listed (Harper, 1975). Most elastomers have limited chemical resistance and tend to swell or even dissolve in most of the solvents. When preparing membranes from these materials, this characteristic mostly results in a high permeability, but in a rather poor selectivity and stability. When coated on a support layer, the swollen elastomer can crack or delaminate from the substrate, because of increased interfacial tensions. This decreased selectivity and stability gets even more problematic at high temperatures. In pressure driven membrane processes, the use of additional cross-linking (e.g. WO 96/27430) and the selection of more stable rubbers, like fluorosilicones (e.g. U.S. Pat. No. 4,748,288), have been suggested as solutions for this kind of problem.

TABLE 2
Chemical resistance of elastomers in organic solvents.

| | | Aromatic | Aliphatic | Chlorinated | |
|---|---|---|---|---|---|
| | Alcohols | solvents | solvents | solvents | Esters |
| IR | Good | Poor | Poor | Poor | Poor |
| BR | Good | Poor | Poor | Poor | Poor |
| SBR | Good | Poor | Poor | Poor | Poor |
| EPDM | Good | Fair | Poor | Poor | Poor |
| CSM | Good | Poor | Fair | Poor | Poor |
| CR | Good | Fair | Good | Fair | Good |
| NBR | Good | Good | Excellent | Fair | Poor |
| PDMS | Excellent | Fair | Good | Good | Good |
| Fluorosili- | Good | Excellent | Excellent | Excellent | Good |
| cone | | | | | |
| Polysulfides | Good | Excellent | Excellent | Excellent | Good |
| Polyurethane | Fair | Good | Excellent | Fair | Poor |
| Polyacrylate | Poor | Fair | Good | Fair | Poor |

Poor: dissolution of elastomer; Fair: strong (excessive) swelling, little dissolution of elastomer; Good: swelling, no dissolution; Excellent: no changes

This invention relates to the addition of fillers to the elastomer. In this invention, fillers are defined as particles from an inorganic or organic nature, which are in a solid state and interact chemically and/or physically with the elastomer to cause an additional cross-linking. Hence, the swelling of the elastomer in high-swelling solvents and at high temperatures is reduced.

An important characteristic of the filler related to this invention is the additional cross-linking, which is a result of a chemical and/or physical interaction between the filler. The most relevant method to reveal whether or not additional cross-linking is established, is to measure the swelling of the filled elastomers in high-swelling solvents, like toluene, ethyl acetate... and to compare the swelling with the swelling of the unfilled membrane.

Swelling measurements typically proceed as follows:

Dried pieces of the membrane are weighed and submerged in the solvent until swelling equilibrium is reached. The swelling S of membrane x is then:

$${S}_{x} ( ml \text{/} g ) = \frac{( \frac{{m}_{eq} - {m}_{0}}{{m}_{0}} )}{ρ ( solv )}$$

where m_{eq}=weight of the membrane at swelling equilibrium, m₀=weight of the dried sample and ρ(solv)=density of the used solvent (g/ml).

The swelling reduction ΔS in a certain solvent can be expressed by following equation:

$$Δ S ( \% ) = \frac{{S}_{ref} - {S}_{filled}}{{S}_{ref}} \times 100$$

where ΔS=swelling reduction, S_{ref}=swelling of the membrane without filler in this solvent and S_{filled}=swelling of membrane with filler in the same solvent.

The swelling reduction ΔS for a given elastomer depends on the type of filler, its interactions with the elastomer and the filler content. This patent relates to membranes for which the swelling reduction caused by the addition of a filler leads to a swelling that decreases by at least 3%, preferably more than 30%.

The fillers can be inorganic or organic. Zeolitic fillers, silsesquioxanes, alumina, zirconia titania, clay minerals and silicas are examples of the possible inorganic fillers, while graphite, powdered coal and carbon black materials are examples of organic particles.

Different kinds of interactions can take place. Elastomers can physically adsorb on fillers, like the adsorption of non-functionalised PDMS chains on the free hydroxyl sites of the filler [Litvinov et al., 1991]. Another example is the adsorption of rubbers on carbon blacks caused by London-dispersion interactions between the rubbers and surface carbon atoms. Very strong interactions can occur when chain segments of the rubber are sterically retained by the surface topology of the filler (Leblanc, 2000).

When functional groups exist on the elastomers, one can aim at chemical (covalent, coordinative or ionic) bonding between these functional groups and groups present on the filler. One example is the two-component PDMS system, where one component carries hydride groups and the other vinyl groups. It is possible to induce a reaction between the hydrides on the polymer and the silanols of a zeolitic filler to form a siloxane-bond. Silsesquioxanes offer other opportunities to generate covalent bonds via the diversity of functionalities (vinyl groups, hydride groups, silanol groups, methacryl groups, . . . ) that can exist on their surface.

Fillers with insufficient affinity for the elastomer can be modified to improve the interaction between filler and elastomer or to convert less reactive functionalities into more reactive ones. These modifications often lead to better dispersions of the filler in the elastomer. One example is the silylation of silica to improve its dispersion in PDMS films.

In the preparation of the hybrid membrane, the filler is first dispersed in an appropriate solvent. To improve the dispersion, ultrasonic wave treatment, high speed mixing, modification reactions, . . . can be applied. The filler can be treated first in a mortar or a ball mill. Obviously, the dispersing solvent should be able to dissolve the elastomer as well, or at least, should be partially miscible with the solvent in which the membrane forming polymer is dissolved.

The content of solid components, i.e. filler and polymer, in the dispersion, may range from 1 wt % to 70 wt %, preferably 5 wt % to 20 wt %. The dispersion is stirred for a certain time to allow (polymer/filler) interactions to establish, to improve dispersion and possibly to let a chemical reaction take place. When appropriate, the dispersion can be heated.

Solvent casting or coating is used as the membrane preparation process. The (polymer/filler) dispersion can be cast on a non-porous support from which it is released afterwards to form a self-supporting film. It is more preferred to coat the dispersion on a polymeric or ceramic support with surface pores in the range from 5 to 1000 ANG, preferably from 10 to 50 ANG. This porous support can be treated first, for instance to diminish intrusion. One way tot realise this is by soaking it previously with a solvent, which has a low affinity for the dispersion. Also, the support can be treated with adhesion promotors.

After casting or coating, the solvent is evaporated and, if necessary, a heat treatment can be applied to finish the cross-linking reactions. The heat treatment can possibly occur under vacuum conditions to remove the remaining solvent. The resulting supported membranes have a dense separating layer, which consists of a filled elastomer. The thickness of this selective layer can range from 0.01 μm to 100 μm, preferably from 0.1 μm to 10 μm.

The resulting membranes are used in pressure driven membrane processes with liquid feeds, like microfiltration, ultrafiltration, nanofiltration, hyperfiltration and reverse osmosis. The membranes are typically used to treat feed solutions that consist of solutes dissolved in a solvent system. The feed solution is separated by the filled elastomeric membranes into a solute enriched retentate and a more dilute permeate. The solutes are organic or inorganic molecules with a molecular weight that can range from 50 to 10000 Dalton, preferably 200 to 1000 Dalton. The solvent system can be one solvent, which is part of the aromatic hydrocarbons, the aliphatic hydrocarbons, halogenated solvents, alcohols, ketones, ethers, aldehydes, esters, nitrites, amines, . . . or can be combinations thereof. The pressure applied as a driving force for transport ranges from 0.5 to 100 bar, more preferably from 5 to 50 bar. Working temperatures typically, but not exclusively, range from 0° C. to 100° C.

### EXAMPLES

Materials

The PDMS (RTV-615 A and B, density 1.02 g/ml) and the adhesion promotor (SS 4155) were obtained from General Electric Corp. (USA). Component A is a prepolymer with vinyl groups. Component B has hydride groups and acts as cross-linker. EPDM Keltan 578) was kindly provided by DSM.

ZSM-5 CBV 3002 and USY CBV-780 were supplied by PQ-corporation and dried at 110° C. before use.

| | USY CBV-780 | ZSM-5 CBV-3002 |
|---|---|---|
| Si/Al | 20 | 240 |
| Crystal size (μm) | 0.4-0.8 | 1-1.5 |
| BET (m²/g) | 738 (micro-) + | 405 |
| | 174 (meso- + macro-) | |
| Void volume | 0.316 (micro-) + | 0.1275 |
| | 0.316 (meso- + macro-) | |

### The main characteristics of the zeoliticfillers used.

The PAN support was kindly provided by VITO, Belgium.

### Example 1

### Swelling Experiments on Unfilled PDMS Membranes (as a reference)

A PDMS solution was prepared in hexane with the RTV 615 A and RTV 615 B components present in a 10/1 ratio, as proposed by the manufacturer to be the ratio for optimal curing. The mixture was prepolymerised for 1 h at 60° C. and poured in a petridish. The solvent was allowed to evaporate for several hours and the resulting film was cured at 100° C. Pieces of the resulting membrane were weighed and submerged in the solvent until swelling equilibrium was reached.

TABLE 1
Swelling for PDMS membranes, measured at room temperature.

| Solvent | Swelling (ml/g) |
|---|---|
| Ethyl acetate | 0.7 |
| Hexane | 1.39 |
| Toluene | 1.01 |

### Example 2

### Swelling Experiments on PDMS-Membranes Filled with ZSM-5 CBV-3002

The zeolite powder was dispersed in hexane. To improve the dispersion, a treatment of one hour in an ultrasonic bath was applied to break crystal aggregates. The cross-linker (RTV 615 B) was added to the zeolite dispersion and this mixture was stirred at 40° C. for two hours to allow sufficient time to establish strong interactions between both phases. Finally, the prepolymer (RTV 615 A) was added and the mixture was stirred for another hour at 60° C. The PDMS/ZSM-5 CBV 3002) solution was poured in a petridish and treated the same way as described in Example 1. The swelling of the membrane loaded with 30 wt % zeolite was measured and compared with the swelling of the reference membrane prepared in Example 1. The content of the solid components (i.e. PDMS and filler) in the casting solution was 18.5 wt %. The RTV 615 A/B ratio for optimal polymer curing was this time adjusted to 7 in order compensate for the loss of hydride groups due to their reaction with the surface silanol groups on the zeolite.

TABLE 2
Comparison of the swelling of a reference PDMS membrane
and a ZSM-5 filled PDMS membrane at room temperature.

| | S_{ref} | S_{filler} | ΔS |
|---|---|---|---|
| Solvent | (ml/g) | (ml/g) | (%) |
| Toluene | 1.01 | 0.80 | 20 |
| Ethyl acetate | 0.7 | 0.496 | 28 |
| Hexane | 1.39 | 0.880 | 38 |

TABLE 3
Comparison of the swelling in 2-propanol of a reference PDMS membrane
and a ZSM-5 filled PDMS membrane as a function of temperature.

| Temperatuur | S_{ref} | S_{filler} | ΔS |
|---|---|---|---|
| (° C.) | (ml/g) | (ml/g) | (%) |
| 30 | 0.168 | 0.278 | 40 |
| 40 | 0.203 | 0.363 | 44 |
| 50 | 0.220 | 0.448 | 51 |
| 60 | 0.269 | 0.533 | 51 |

### Example 3

### Swelling Experiments on PDMS-Membranes Filled with USY CBV-780

The zeolite powder was dispersed in hexane. To improve the dispersion, a treatment of one hour in an ultrasonic bath was applied to break crystal aggregates. The cross-linker was added to the zeolite dispersion and this mixture was stirred for two hours at 40° C. Finally, the prepolymer (RTV 615 A) was added in an RTV 615 A/B ratio adjusted to 7 and the mixture was stirred for another hour at 60° C. The (PDMS/USY CBV 780) solution was poured in a petridish and treated the same way as described in the procedure of Example 1.

The content of the solid components (i.e. PDMS and filler) in the casting solution was 20 wt %, corresponding to a 30 wt % zeolite loading in the final membrane.

TABLE 4
Comparison of the swelling of a reference PDMS membrane and
a USY CBV-780 filled PDMS membrane at room temperature.

| | S_{ref} | S_{filler} | ΔS |
|---|---|---|---|
| Solvent | (ml/g) | (ml/g) | (%) |
| Toluene | 1.01 | 0.420 | 58 |
| Decane | 1.39 | 0.520 | 63 |
| Ethyl acetate | 0.70 | 0.160 | 77 |

### Example 4

### Swelling Experiments on EPDM-Membranes Filled with USY CBV-780

EPDM is poured in hexane and dissolved at 60° C. The filler is added to the EPDM solution and a treatment of one hour in an ultrasonic bath was applied to break crystal aggregates. The (EPDM/filler) solution was poured in a petridish and treated the same way as described in the procedure of Example 1.

The content of the solid components (i.e. EPDM and filler) in the casting solution was 5 wt % in the case USY CBV-780, corresponding to a 30 wt % filler loading in the final membrane.

TABLE 5
Comparison of the swelling of a reference EPDM membrane and
a USY CBV-780 filled EPDM membrane at room temperature.

| | S_{ref} | S_{filler} | ΔS |
|---|---|---|---|
| Solvent | (ml/g) | (ml/g) | (%) |
| Diethylether | 1.90 | 1.20 | 36 |
| Ethyl acetate | 0.172 | 0.167 | 3 |

### Example 5

### Filtration Experiments with Unfilled PDMS Membrane (as a reference)

The membranes used in Examples 1-5 to determine the swelling were self-supporting in order to minimize the experimental error on the measurements. On the other hand, the membranes for the filtration experiments are thin films cast on a supporting layer in order to allow sufficiently high fluxes. A 14 wt % PDMS solution (ILTV 615 A/B=10/1) in hexane was prepolymerised for 1 h at 60° C. The PAN support was saturated with water and glued to a glass or INOX plate. The excess of water was wiped away with a humid tissue and the support was treated with the adhesion promotor, before coating the PDMS solution on the impregnated support. The plate was tilted at an angle 45° and the polymer solution was poured on the PAN support. After evaporation of the hexane, cross-linking was completed in a vacuum oven at 100° C. The thickness of the resulting membrane was 8 μm, as determined via SEM.

Filtrations were done in a stainless steel nanofiltration cell with 15.2 cm² membrane surface area. The feed solution consisted of a 0.207 g/l Wilkinson catalyst solution in a given solvent. 50 ml of the feed solution was poured in the cell, the cell was heated to the desired temperature and subsequently pressurised with nitrogen to 16 bar. Permeate samples were collected in cooled flasks as a function of time, weighed and analyzed. All reported values are equilibrium measurements.

The solvent flux Jₛₒₗᵥₑₙₜ(l.m⁻².h⁻¹.barc⁻¹) is the total amount permeated (l) per unit time (h), per square meter of membrane (m²) and per unit of pressure (bar).

The rejection R (%) at steady state is a measure for the ability of a membrane to retain a certain solute. It is defined as follows:

$$R ( \% ) = 100 \times ( 1 - \frac{{C}_{p}}{{C}_{f}} )$$

with Cₚ the concentration in the permeate and C_{f} the concentration in the feed.

TABLE 6
Flux and Wilkinson catalyst retention values for the unfilled PDMS
membrane. Pressure: 16 bar; ^{a}tested at 40° C.; ^{b}tested at 45° C.

| | |
|---|---|
| Flux (1/(m² · h · bar)) | Retentie (%) |

| PDMS | 30° C. | 50° C. | 80° C. | 30° C. | 50° C. | 80° C. |
|---|---|---|---|---|---|---|
| Toluene | 1.15 | 1.50 | | 78 | 0 | |
| Ethyl acetate^{a} | 1.14 | 1.25 | | 62 | 0 | |
| DCM | 1.54 | 1.61^{a} | | 81 | 6^{a} | |
| Acetone | 0.48 | 0.64 | | 70 | 0 | |
| 2-propanol | 0.24 | 0.28^{b} | | 52 | 0^{b} | |

### Example 6

### Filtration Experiments with PDMS Membranes Filled with ZSM-5 CBV-3002

The (PDMS/ZSM-5 CBV 3002) dispersion of Example 2 was coated on a PAN support following the procedure of Example 6.

The content of the solid components (i.e. PDMS and filler) in the coating solution was 18.5 wt %, corresponding to a 30 wt % zeolite loading in the final membrane. The thickness of the resulting membrane was 20 μm, as determined via SEM. The filtration was tested as described in Example 6.

TABLE 7
Flux and Wilkinson catalyst retention values for PDMS membrane
filled with ZSM-5 CBV-3002. Pressure: 16 bar; ^{a}tested at 40° C.;
^{b}tested at 45° C.

| | | |
|---|---|---|
| PDMS + | | |
| ZSM-5 | Flux (l/(m² · h · bar)) | Retentie (%) |

| CBV 3002 | 30° C. | 50° C. | 80° C. | 30° C. | 50° C. | 80° C. |
|---|---|---|---|---|---|---|
| Toluene | 0.58 | 0.72 | 0.84 | 98 | 98 | 88 |
| Ethyl acetate^{a} | 0.55 | 0.66 | 0.87 | 97 | 97 | 84 |
| DCM | 0.7 | 0.77^{a} | | 90 | 43 | |
| Acetone | 0.17 | 0.25 | | 94 | 92 | |
| 2-propanol | 0.031 | 0.061^{b} | | 98 | 98^{b} | |

### Example 7

### Filtration Experiments with PDMS Membranes Filled with USY CBV-780

The zeolite powder was dispersed in hexane. To improve the dispersion, a treatment of one hour in an ultrasonic bath was applied to break crystal aggregates. The cross-linker was added to the zeolite dispersion and this mixture was stirred for two hours at 40° C. Finally, the prepolymer (RTV 615 A) was added in an RTV 615 A/B ratio adjusted to 6.5 and the mixture was stirred for another hour at 60° C. The CPDMS/USY CBV-780) solution was coated on the PAN support, as in Example 6.

The content of the solid components (i.e. PDMS and filler) in the coating solution was 20 wt %, corresponding to a 30 wt % zeolite loading in the final membrane.

TABLE 8
Flux and Wilkinson catalyst retention for the PDMS membrane
filled with USY CBV 780. Pressure: 20 bar

| | | |
|---|---|---|
| PDMS + USY | Flux (l/(m² · h · bar)) | Retentie (%) |

| CBV 780 | 30° C. | 50° C. | 30° C. | 50° C. |
|---|---|---|---|---|
| Toluene | 0.18 | 0.27 | 98 | 98 |
| Ethylacetate | 0.20 | | 94 | |
| Acetone | 0.10 | | 95 | |

### Example 8

### Filtration Experiments with EPDM Membranes Filled with USY CBV-780

The (EPDM/USY) dispersion of Example 4 was coated on a PAN support following the procedure of Example 6.

TABLE 9
Flux and Wilkinson catalyst retention for the EPDM membrane filled
with USY CBV-780. Pressure: 30 bar, Temperature: 50 ° C.

| Ethyl acetate | Flux (l/(m² · h · bar)) | Retentie (%) |
|---|---|---|
| EPDM | 0.07 | 35 |
| EPDM + USY | 0.047 | 75 |
| CBV-780 (30 wt %) | | |

### REFERENCES TO THIS APPLICATION

Bhanushali D., Kloos S., Kurth C. and Bhattacharyya D. (2001), J. Mem. Sci. 189, 1-21

Bitter J. G. A., Haan J. P. and Rijkens H. C. (1988) U.S. Pat. No. 4,748,288

Chen X., Ping Z. and Long Y. (1998) J. Appl. Pol. Sci. 67, 629-636

Harper, C. A. (1975), Handbook of plastics and elastomers, MacGraw-Hill New York

Jia M. -D., Peinemann K. -V. and Behling R. -D. (1991), J. Mem. Sci. 57, 289-296

Leblanc J. L. (2000) J. Appl. Pol. Sci., 78, 1541-1550.

Linder C., Nemas M., Perry M. and Katraro R. (1993) U.S. Pat. No. 5,205,934

Linder C., Nemas M., Perry M. and Katraro R. (1993) U.S. Pat. No. 5,265,734

Litvinov V. M. and Spiess H. W. (1991) Makromol. Chem. 192, 3005-3019

Miller J. F., Bryant D. R., Hoy K. L., Kinkade N. E. and Zanapalidou R. H. (1997) U.S. Pat. No. 5,681,473

Mulder, M. (1996) Basic Principles of Membrane Technology, Kluwer

Qureshi N., Meagher M. M. and Hutkins R. W. (1999) J. Mem. Sci. 158, 115-125

Raman L. P., Cheryan M. and Rajagopalan. (1996) J. Am. O.C. Soc. 73, 219-223

Tantekin-Ersolmaz B., Senorkyan L, Kalaonra N., Tatlier M. and Erdem-Senatalar A. (2001) J. Mem. Sci., 189, 59-67

te Hennepe H. J. C. (1988) PhD thesis, University of Twente, The Netherlands

te Hennepe H. J. C., Bargeman D. Mulder M. H. V. ans Smolders C. A. (1987) J. Mem. Sci., 35, 39-55

Vankelecom I. F. J., Depré D., De Beuckelaer S. and Uytterhoeven J. B. (1995) J. Phys. Chem., 99, 13193-13197

1-14. (canceled)

15. A pressure-driven process for the separation of liquid feeds through a membrane, in which disturbance of the pressure-driven separation is decreased or prevented by a separation membrane comprising an elastomer in which a filler is dispersed in such a way that the filler/matrix interactions limit swelling of the membrane.

16. The pressure-driven separation process of claim 15, wherein two or more components are separated over a membrane by means of a pressure gradient driven by a pressure generated at the feed site.

17. The pressure-driven separation process of claim 15, wherein the filler acts as a cross-linker for the elastomer.

18. The pressure-driven separation process of claim 15, wherein the filler is a molecular sieve or porous material with nanometer dimension windows, channels or cavity architectures.

19. The pressure-driven separation process of claim 15, wherein the filler is silica, alumina, titania or a carbon molecular sieve.

20. The pressure-driven separation process of claim 15, wherein the filler is a molecular sieve or porous material having pores with a median diameter in the range 0.3-10 nm.

21. The pressure-driven separation process of claim 15, wherein said elastomeric membrane contains a filler that results in a swelling reduction of the elastomeric membrane of at least 3%.

22. The pressure-driven separation process of claim 15, wherein said swelling reduction results in an increase of the rejection of the elastomeric membrane for solutes of at least 3%.

23. The pressure-driven separation process of claim 15, wherein said filler is a zeolite.

24. The pressure-driven separation process of claim 15, wherein said filler is a zeolite having a ZSM-5 structure.

25. The pressure-driven separation process of claim 15, wherein said filler is a zeolite having a USY structure.

26. The pressure-driven separation process of claim 15, wherein said elastomer is a polysiloxane.

27. The pressure-driven separation process of claim 15, wherein said elastomer is a polydimethylsiloxane.

28. The pressure-driven separation process of claim 15, wherein said elastomer is EPDM.
